(19) United States
(12) Patent Application Publication
(10) Pub. No.: US 2004/0097120 A1
(43) Pub. Date: May 20, 2004

(54) Safety cage for electrical plugs

(76) Inventors: Jamie A. Limber, Gilbert, AZ (US); Robert I. Vasquez, Phoenix, AZ (US)

Correspondence Address: The Halvorson Law Firm, Ste 1, 405 W. Southern Ave., Tempe, AZ, 85282, US

(21) Appl. No.: 10/294,173

(22) Filed: Nov. 14, 2002

(51) Int. Cl. H01R 13/62

(52) U.S. Cl. 439/369

(57) ABSTRACT

Described is a device that snaps over inserted female and male ends of plugs located at each end of an extension cord and/or electrically powered equipment. The shell helps keep the mail and female plug in electrical connection. The shell protects the plugs from foreign objects and may be made either water resistant or pervious to air for cooling purposes. The shell allows the consumer or decorator to space lights evenly when dealing with the end of a light string strand, since there is usually a lead of two or more feed from the first outlet to the first bulb.

### FIELD OF THE INVENTION

The present invention relates to the field of safety devices. More specifically, the present invention relates to the field safety devices that are used with electrical plugs, such as ornamental light strings, extension cords, electrical equipment and the like.

### BACKGROUND

Electrical equipment, such as electrically powered tools, ornamental light strings, extension cords, and the like are often plugged into extension cords. In these instances, the electrical equipment has a male plug that is inserted into the female plug of the extension cord.

However, this electrical connection is subject to many environmental factors. This is especially true when the electrical equipment is an ornamental light string and the extension cord is another ornamental light string (or a simple extension cord). In these instances, the electrical connection may be outside for extended periods of time and therefore subject to inclement conditions, such as rain, snow, sleet, airborne debris, and the like.

Also, electrically powered equipment may be moved about while in use. Examples are electrically powered lawn mowers and power tools such as drills and saws. In these cases the electrical connection is subject to being inadvertently pulled apart.

Thus, it can be seen that there is a present need for a device that would help maintain the electrical connection between male and female plugs and that further may provide some protection from inclement environmental conditions.

### SUMMARY OF INVENTION

It is an object of the present invention to provide a device that is used to help maintain a male electrical plug/female electrical plug connection.

It is another object of the present invention to provide the above device and to further have the device provide protection from inclement environmental conditions.

The novel features that are considered characteristic of the invention are set forth with particularity in the appended claims. The invention itself, however, both as to its structure and its operation together with the additional object and advantages thereof will best be understood from the following description of the preferred embodiment of the present invention when read in conjunction with the accompanying drawings. Unless specifically noted, it is intended that the words and phrases in the specification and claims be given the ordinary and accustomed meaning to those of ordinary skill in the applicable art or arts. If any other meaning is intended, the specification will specifically state that a special meaning is being applied to a word or phrase. Likewise, the use of the words “function” or “means” in the Description of Preferred Embodiments is not intended to indicate a desire to invoke the special provision of 35 U.S.C. §112, paragraph 6 to define the invention. To the contrary, if the provisions of 35 U.S.C. §112, paragraph 6, are sought to be invoked to define the invention(s), the claims will specifically state the phrases “means for” or “step for” and a function, without also reciting in such phrases any structure, material, or act in support of the function. Even when the claims recite a “means for” or “step for” performing a function, if they also recite any structure, material or acts in support of that means of step, then the intention is not to invoke the provisions of 35 U.S.C. §112, paragraph 6. Moreover, even if the provisions of 35 U.S.C. §112, paragraph 6, are invoked to define the inventions, it is intended that the inventions not be limited only to the specific structure, material or acts that are described in the preferred embodiments, but in addition, include any and all structures, materials or acts that perform the claimed function, along with any and all known or later-developed equivalent structures, materials or acts for performing the claimed function.

### BRIEF DESCRIPTION OF THE DRAWING

FIG. 1 is perspective view of the device according to the present invention.

FIG. 2 is a bottom view of the device according to the present invention.

FIG. 3 is a view of one side of the device according to the present invention.

FIG. 4 is a view of the opposite side of the device according to the present invention.

FIG. 5 is a top view of the device according to the present invention.

FIG. 6 is a view on one end of the device according to the present invention.

FIG. 7 is a view of the opposite end of the device according to the present invention.

FIG. 8 illustrates the use of the device according to the present invention.

FIG. 9 illustrates the use of an alternate embodiment of the device according to the present invention that provides protection against inclement environmental conditions.

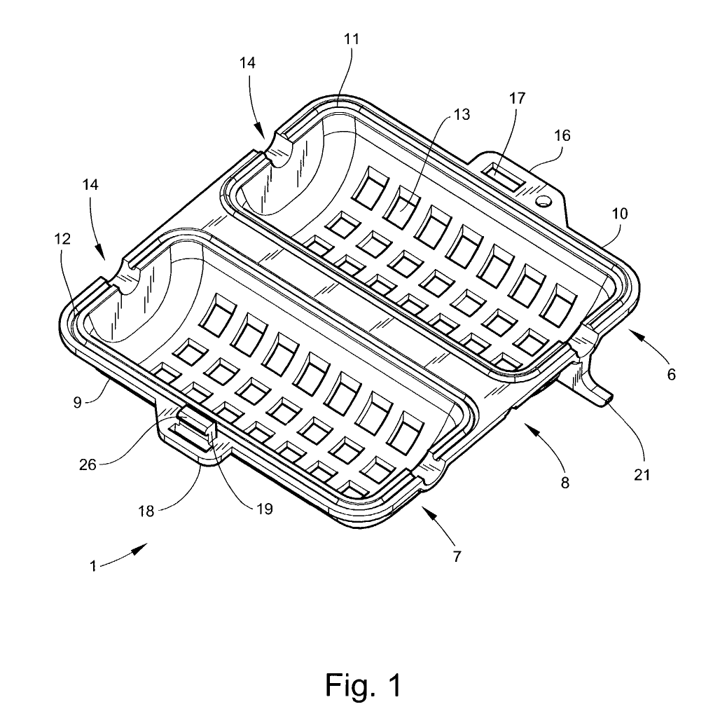

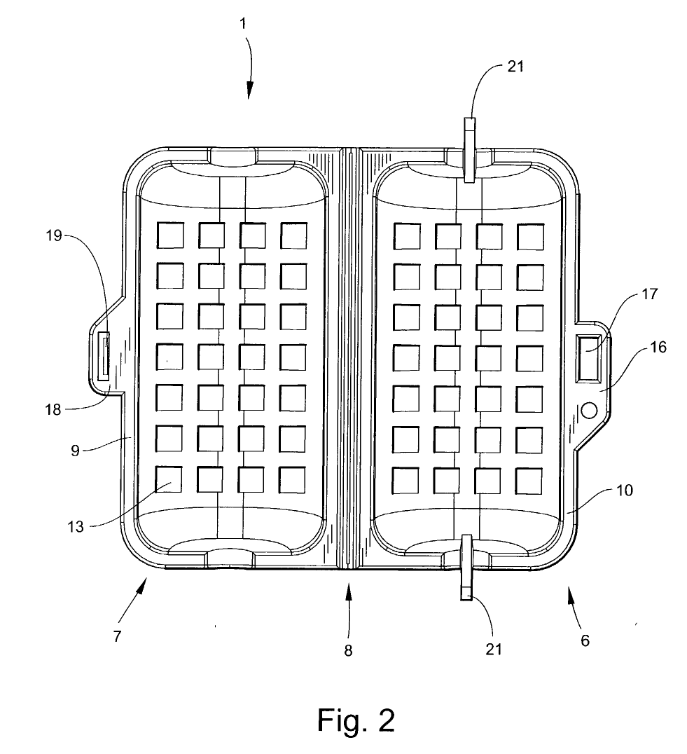

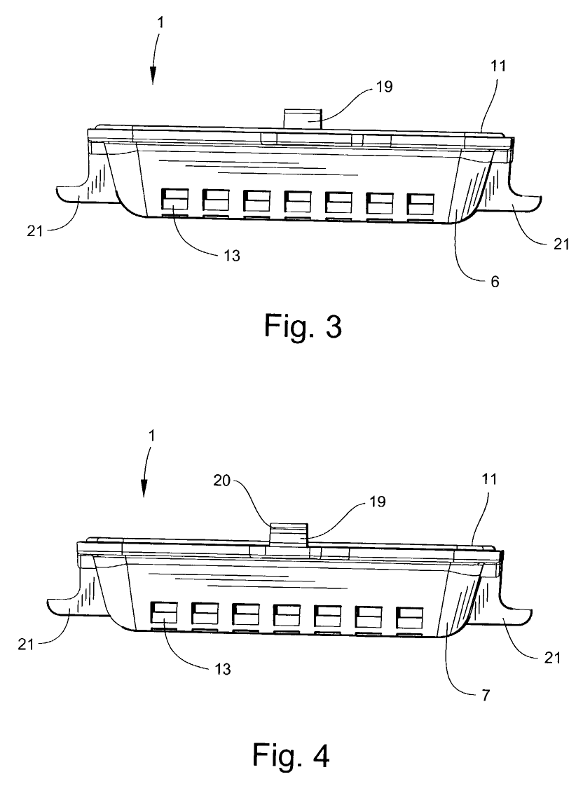

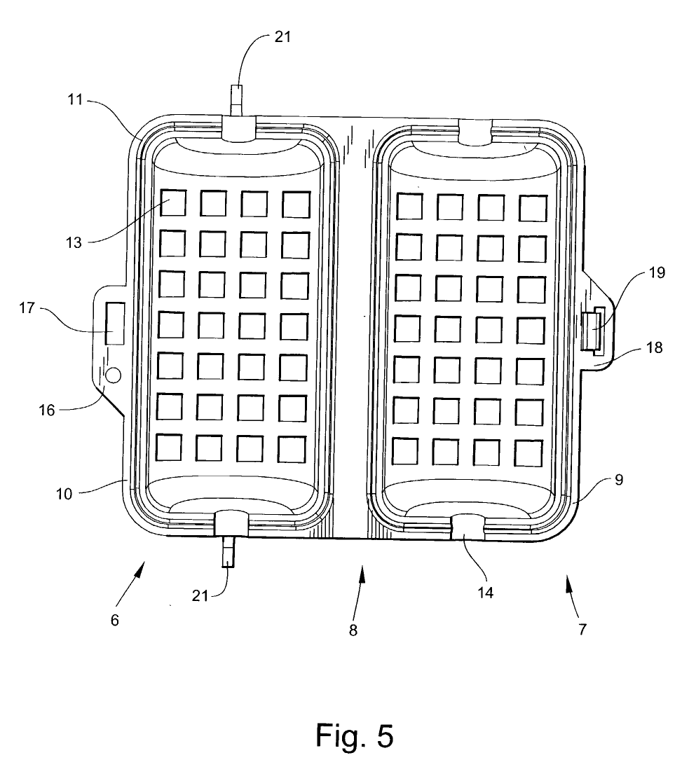

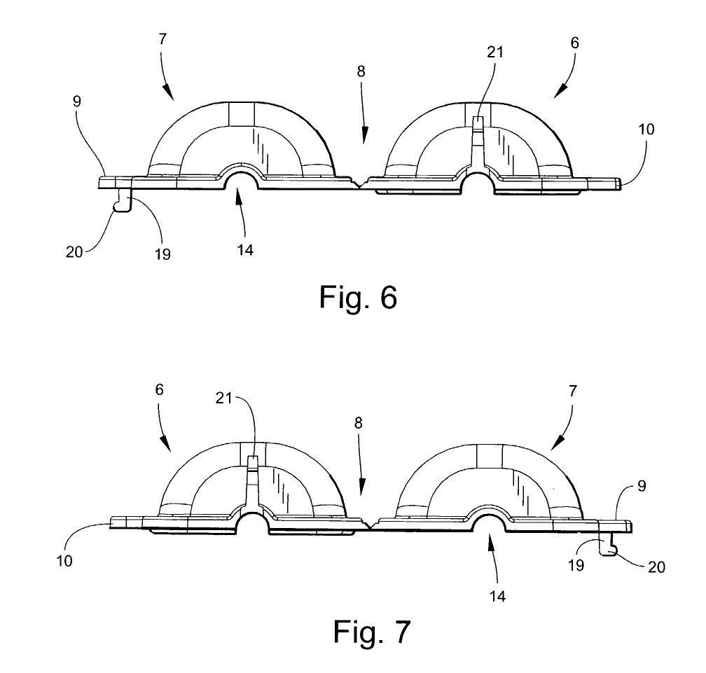

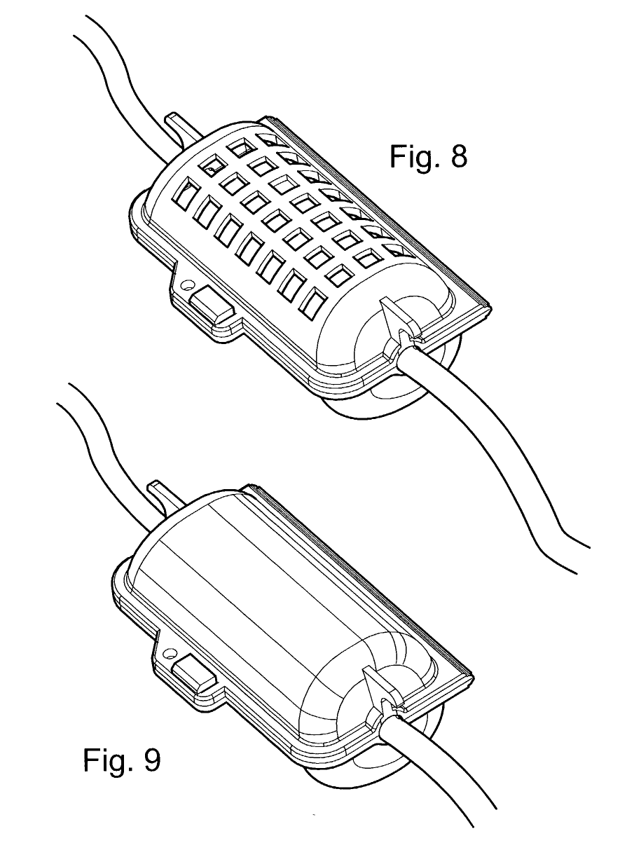

### DETAILED DESCRIPTION OF PREFERRED EMBODIMENTS

The present invention is useful for helping maintain a male/female electrical plug connection.

The device 1 of the present invention is a cage 5 having two halves, 6 and 7, that are connected by a hinge 8. In the preferred form the hinge made from molded plastic and is in the form of a “living hinge”, that is well known in the industry. Each half, 6 and 7, has a perimeter lip, 9 and 10, that, when the two halves are brought together, seal and/or lock to each other. In one embodiment the lips, 9 and 10, each have a flat surface and the two flat surfaces mate to each other. In another embodiment, one lips 9 has a raised projection 11 that extends substantially around the lip 9, while the other lip 10 has a channel 12 that extends substantial around the lip 10. In this manner, when the two halve, 6 and 7, are brought together, the raised projection 11 fits within the channel 12 and provides an seal against external conditions.

In a preferred embodiment, the two halves 6 and 7 are semi-cylindrical in shape, however other shapes may be used that can contain a male/female electrical connection, and still fall within the scope of the present invention. In one embodiment, the two halves 6 and 7 are unbroken surfaces, while an alternate embodiment has the two halves 6 and 7 having a plurality of apertures 13 that allow air flow.

Located at each end of each half 6 and 7, preferably at approximately the mid-point of the end, is a cut-out 14 in the perimeter lip. When the two halves are brought together, the two cut-outs 14 on each end form an aperture that receives an electrical cord. Thus, it can be easily seen that one end receives the electrical cord of the male plug and the other end receives the electrical cord of the female plug.

On the side of the two halves 6 and 7 opposite that of the hinge 8 is a securing mechanism 15. In the preferred embodiment, the securing mechanism 15 comprises a first projection 16 with a receiving aperture 17, located on one half, such as 6. The other half, such as 7 has a second projection 18 and a clasp tang 19 that is sized to fit within and be received by the receiving aperture 17. In its most preferred form the clasp tang 19 includes a barb 20 that can be forced through the receiving aperture 17 and provides a resilient bias against unwanted opening of the two halves 6 and 7.

Finally, in yet another embodiment, the device 1 may include two electrical cord retaining tangs 21. These electrical cord retaining tangs 21 are preferably located one at each end of a half, the same half. Alternate locations may be used and still fall within the scope of the present invention.

In use, a male electrical plug is inserted into a female electrical plug. The device 1 according to the present invention is place around the male/female electrical connection and the two halves 6 and 7 are brought together. When the securing mechanism 15 is provided, the two halves 6 and 7 are brought together until the securing mechanism 15 engages. In the embodiment with the electrical cord retaining tangs 21, excess electrical cord that projects from the device 1 of the present invention that the user want secured, such as excess electrical lead in ornamental light strings, may be wrapped around the two halves 6 and 7 and secured using the two electrical cord retaining tangs 21.

The preferred embodiment of the invention is described above in the Drawings and Description of Preferred Embodiments. While these descriptions directly describe the above embodiments, it is understood that those skilled in the art may conceive modifications and/or variations to the specific embodiments shown and described herein. Any such modifications or variations that fall within the purview of this description are intended to be included therein as well. Unless specifically noted, it is the intention of the inventor that the words and phrases in the specification and claims be given the ordinary and accustomed meanings to those of ordinary skill in the applicable art(s). The foregoing description of a preferred embodiment and best mode of the invention known to the applicant at the time of filing the application has been presented and is intended for the purposes of illustration and description. It is not intended to be exhaustive or to limit the invention to the precise form disclosed, and many modifications and variations are possible in the light of the above teachings. The embodiment was chosen and described in order to best explain the principles of the invention and its practical application and to enable others skilled in the art to best utilize the invention in various embodiments and with various modifications as are suited to the particular use contemplated.

What is claimed is:

1) A device that secures a male/female electrical plug connection comprising two halves connected by a hinge, each halve comprising a perimeter lip, a cut-out in the perimeter lip on each end of each of the two halves, the device further comprising a securing mechanism when the two halves are brought together.

2) The device according to claim 1 wherein the perimeter lips of each of the two halves further comprise flat surfaces will mate to each other when the two halves are brought together.

3) The device according to claim 1 wherein the perimeter lips of the two halves further comprise a raised projection on one perimeter lip and a channel in the other perimeter lip, the raised projection and channel extending substantially along each of the perimeter lip, respectively, and the raised projection fitting into the channel when the two halves are brought together.

4) The device according to 2 wherein each of the two halves further includes a plurality of apertures therein.

5) The device according to 3 wherein each of the two halves further includes a plurality of apertures therein.

6) The device according to claim 2 wherein the securing mechanism further comprises a first projection with a receiving aperture located on one half and a second projection with a clasp tang that is sized to fit within and be received by the receiving aperture on the other half.

7) The device according to claim 3 wherein the securing mechanism further comprises a first projection with a receiving aperture located on one half and a second projection with a clasp tang that is sized to fit within and be received by the receiving aperture on the other half.

8) The device according to claim 2 further comprising two electrical cord retaining tangs located on at each end of one of the two halves.

9) The device according to claim 3 further comprising two electrical cord retaining tangs located on at each end of one of the two halves.

10) The device according to claim 4 further comprising two electrical cord retaining tangs located on at each end of one of the two halves.

11) The device according to claim 5 further comprising two electrical cord retaining tangs located on at each end of one of the two halves.

12) The device according to claim 6 further comprising two electrical cord retaining tangs located on at each end of one of the two halves.

13) The device according to claim 7 further comprising two electrical cord retaining tangs located on at each end of one of the two halves.
